(19) United States
(12) Patent Application Publication
(10) Pub. No.: US 2008/0144576 A1
(43) Pub. Date: Jun. 19, 2008

(54) Systems and methods for allowing IP address handoff for mobile devices

(75) Inventors: Heng Pan, Shanghai (CN); Shuxin Liu, Shanghai (CN); Guichang Fang, Shanghai (CN)

Correspondence Address: FULBRIGHT & JAWORSKI L.L.P, 2200 ROSS AVENUE, SUITE 2800, DALLAS, TX, 75201-2784, US

(73) Assignee: Adaptix, Inc., Seattle, WA (US)

(21) Appl. No.: 11/651,179

(22) Filed: Jan. 9, 2007

(30) Foreign Application Priority Data
Dec. 14, 2006 (CN) 200610162364.5

(51) Int. Cl. H04Q 7/00

(52) U.S. Cl. 370/331

(57) ABSTRACT

The present invention is directed to a system and method which mobile devices can be handed from one access point to another while maintaining continuous communication with a network and without changing the device's IP address. In an embodiment, when a device is leaving the air interface range of its home access point, it establishes a connection with an intermediary access point. In an embodiment, the communications from the network are directed to the original access point using the original IP address for the device, and forwarded to the device via the intermediary access point. Communications from the device are routed through the intermediary access point and then either directly to the network, or else through the home access point to the network. The IP address handoff is repeated between intermediary access points until the device either returns to the home access point or ceases communication with the network.

### RELATED APPLICATIONS

This application is related to and claims priority to Chinese Application No. 200610162364.5 filed Dec. 14, 2006, entitled “SYSTEMS AND METHODS FOR ALLOWING IP ADDRESS HANDOFF FOR MOBILE DEVICES”, the disclosure of which is hereby incorporated herein by reference.

### TECHNICAL FIELD

This invention relates to wireless communication systems and more particularly to such systems that use IP addresses for data communication and even more particularly to systems and methods for achieving fast handoff in situations where IP addresses are handled on a dynamic basis.

### BACKGROUND OF THE INVENTION

Wireless communication has come of age now where any number of devices are communicating with other devices over an air interface. Many of these communications use an address, such as an IP address, of the device in order to have the communications delivered properly. In cases where a device, for example, a computer, is wired into a network (such as the Internet) the device is assigned an IP address either permanently (static IP address) or more commonly via a dynamic allocation of the IP address on a temporary basis (dynamic IP address). In this regard, the Dynamic Host Configuration Protocol, (DHCP) is typically used for assigning dynamic IP addresses to devices on a network. With dynamic addressing, a device can have a different IP address every time it connects to the network. The DHCP supports a mix of static and dynamic IP addresses.

As devices become portable, an air interface is established between the device and the network, usually via an access point located at a fixed physical location. In some situations the access point, using the DHCP, assigns an IP address to the portable device for the duration of a communication session. However, problems exist when the portable device is moved to a new location. In the simple situation, the user simply turns off the device (or leaves the area served by the air interface), moves the device to a new location and connects to a new access point via a new air interface and receives a new IP address.

A more difficult scenario occurs when the device user desires to use the device as the device is being moved from one air interface to another. For example, assume a user is using a device in his/her home (or office) and then takes the device and walks a few blocks for a coffee. Also assume that the user desires to use the device continuously while walking those few blocks. Also assume that the original air interface in the user's home does not extend all the way to the coffee shop. This last scenario is only possible if there is an air interface available that spans the boundaries of the home and coffee shop's respective air interfaces. However, even if such a spanning air interface exists, maintaining a continuous communication connection to the network is difficult at best.

### BRIEF SUMMARY OF THE INVENTION

The present invention is directed to a system and method which mobile devices can be handed from one access point to another while maintaining continuous communication with a network by allowing the device to keep its assigned IP address for the duration of a communication session. In one embodiment, when a device is leaving the air interface range of its home base it establishes a new (temporary) air interface connection to an intermediary (neighbor) network access point and provides that access point with its existing IP address. The intermediary access point then uses the existing IP address to route communications to and from the device using the original IP address assigned to that device. In one embodiment the communications from the network are directed to the original access point and relayed from there to the intermediary access point while communications from the device are received by the intermediary access point and sent directly to the network. This IP address handoff is repeated between intermediary access points until the device is connected to the final destination access point, all the while keeping its original IP address.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows the assignment of IP addresses in accordance with the prior art;

FIGS. 2A, 2B, 3A and 3B show embodiments of an arrangement for transferring access points while maintaining the IP address;

FIGS. 4A, 4B and 4C show embodiments of an arrangement for returning a mobile device back to a starting access point; and

FIG. 5 illustrates one embodiment of a method for achieving the objectives of the invention.

### DETAILED DESCRIPTION OF THE INVENTION

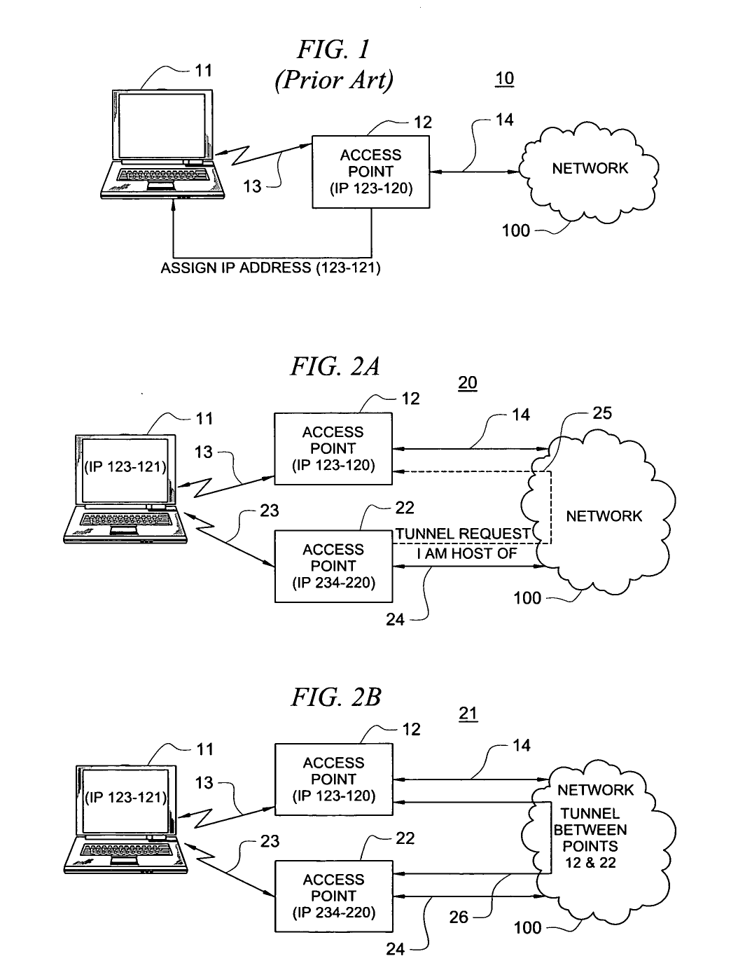

FIG. 1 shows the assignment of IP addresses in accordance with the prior art such that access point 12 is connected to network 100 via bi-directional communication channel 14. Typically, this channel would be a high speed channel which could be wireless or wireline which allows access point 12 to gain access to, for example, the Internet and to exchange information from other access points with respect to network 100 or other networks connected to network 100.

Mobile device 11 is in communication with access point 12 via air interface 13 which, for example, can be any one of a number of protocols, such as the 802.16e protocol. Access point 12 then assigns an IP address which may or may not be part of the subnet associated with the IP address of access point 12. Thus, assuming an IP address of access point 12 as IP 123-120 then, for example, access point 12 could assign IP address of 123-121 to mobile device 11.

This IP address can be assigned, for example, using the DHCP protocol or may be static. It operates such that communications from any user on network 100 are directed to device 11 simply by using IP address 123-121 with respect to each communication. The network knows to send packets with the address 123-121 over communication link 14 to access point 12, and access point 12 knows to use air interface 13 between itself and device 11 for the delivery of the data packet. Data from device 11 is transferred in the opposite direction via air interface 13, access point 12 and communication link 14 to network 100, and via network 100 to the destination associated with whatever IP address is associated with the data from device 11.

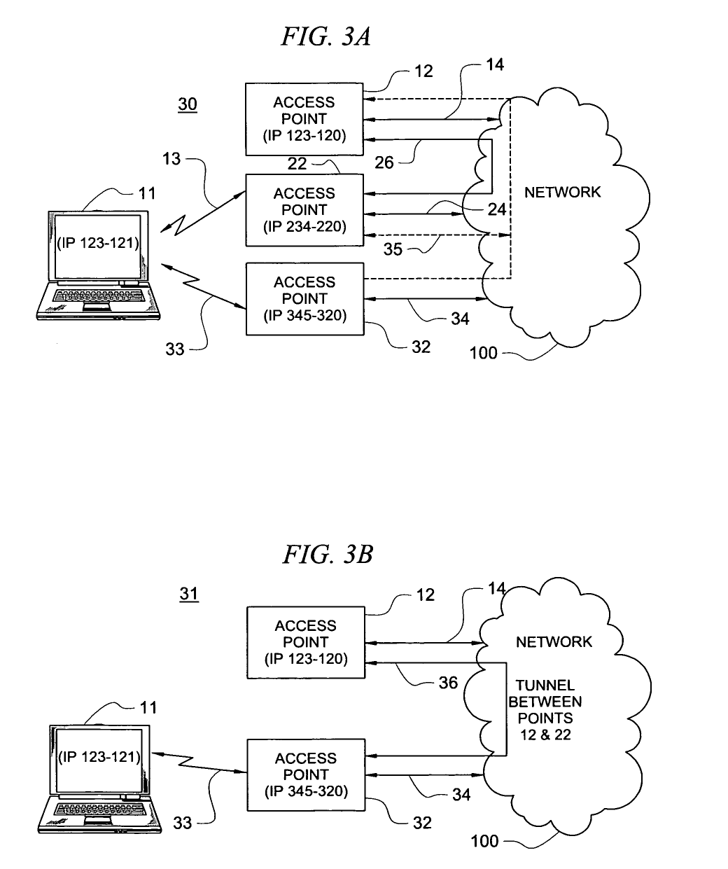

FIG. 2A shows embodiment 20 which illustrates the first step in the transferring of device 11 from one access point to a next access point. Thus, we can assume device 11 is connected via air interface 13 to access point 12 as discussed with respect to FIG. 1. Assume now that device 11 begins to move out of the range of access point 12 and comes in range at access point 22. Access point 22 is accessed from network 100 using IP address 234-220 over link 24. While still in range of both access points, device 11 makes contact with access point 22 via air interface 23. Device 11 then begins communication with access point 22 which realizes that device 11 already has an active IP address of 123-121. Access point 22 then requests access point 12 to set up a tunnel between itself and access point 12 using link 25. When the handover is completed, access point 22 sends a message to access point 12 that access point 22 is the host of device 11. This then allows access point 12 to, as will be discussed, drop connection 13.

FIG. 2B shows the completed connection where data packets from network 100 addressed to address 123-121 are routed over link 14 to access point 12, through tunnel 26 to access point 22, and then to device 11 via air interface 23. Device 11 is connected only to device 22 via air interface 23 while still maintaining the IP address 123-121 as assigned by access point 12. Note that while packets having address 123-121 were previously directed by network 100 over communications link 14 to access point 12 and then to device 11 via air interface 13, they are now forwarded to access point 22 for delivery to device 11 via air interface 23.

Outgoing data packets from device 11 to network 100 may be routed from access point 22 through tunnel 26 to access point 12 and then through link 14 to network 100, or may be routed from access point 22 directly to network 100 through link 24.

FIG. 3A shows device 11 moving from access point 22 to access point 32 in a similar manner as device 11 moved from access point 12 to access point 22. Access point 32 is accessed from network 100 using IP address 345-320 over link 34. Access points 12 and 22 must be informed that packets intended for device 11 should now be forwarded to access point 32 instead of to access point 22. Either access point 32 may inform both access points 12 and 22 of this change using link 35, or else access 32 point may inform access point 22, which in turn informs access point 12, possibly using tunnel 26. After a tunnel is set up between access points 12 and 32 access point 22 is then no longer a link in the connection from device 11 to network 100.

FIG. 3B shows the completed connection where data packets from network 100 addressed to address 123-121 are routed over link 14 to access point 12, through tunnel 36 to access point 32, and then to device 11 via air interface 33. Device 11 is connected only to device 32 via air interface 33 while still maintaining the IP address 123-121 as assigned by access point 12. Note that while packets having address 123-121 were previously directed by network 100 over communications link 14 to access point 12 and then to device 11 via air interface 13, they are now forwarded to access point 32 for delivery to device 11 via air interface 33. Outgoing data packets are handled in a similar manner as discussed above for access point 22. That is, outgoing packets may either be routed through tunnel 36 and access point 12, or directly to network 100 through link 34.

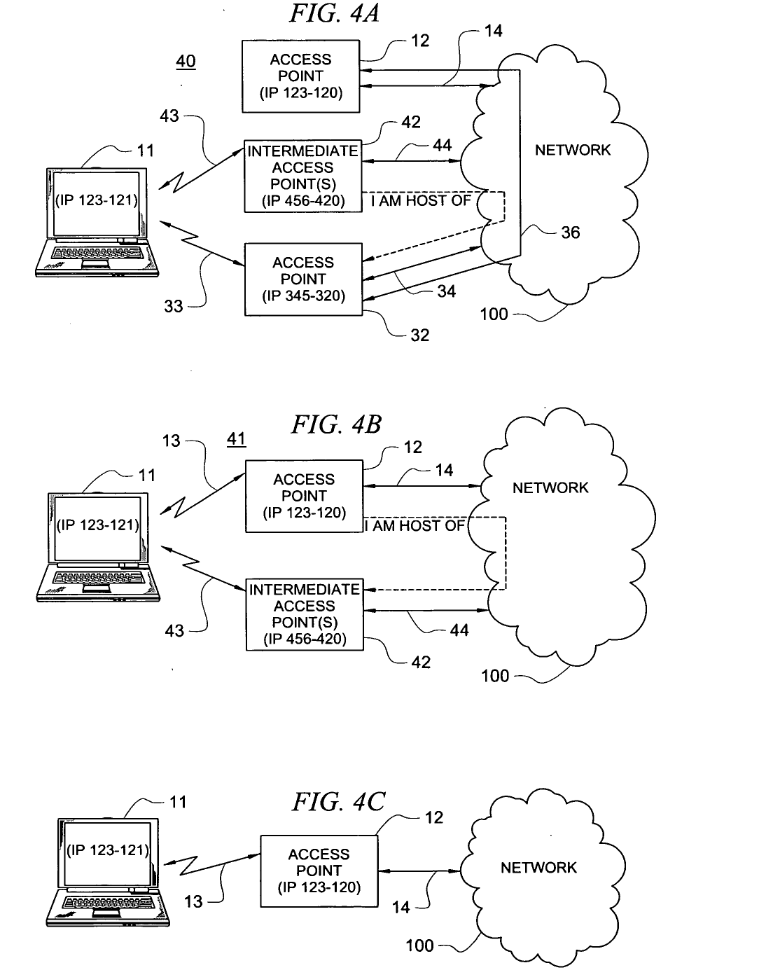

FIGS. 4A and 4B illustrate the situation where device 11 moves from access point 32 to access point 42 and from access point 42 back to access point 12. Note that intermediate access point 42 communicates with network 100 via bi-directional channel 44 and communicates to device 11 over air interface 43. Access point 42 is not necessarily the same as access point 22 illustrated in FIG. 3A. Device 11 is not constrained to move back toward access point 12 using the reverse route as was taken when moving from access point 12 to access point 32.

FIG. 4B shows the continued progress of device 11 back towards access point 12 and FIG. 4C shows device 11 back at original access point 12. Note that during all of the movement of device 11 between access points, the IP address originally assigned for this session has continued to be the same. Thus, communications from network 100 have been delivered back and forth bi-directionally to/from device 11 using the same IP address without regard to which access point was serving the device.

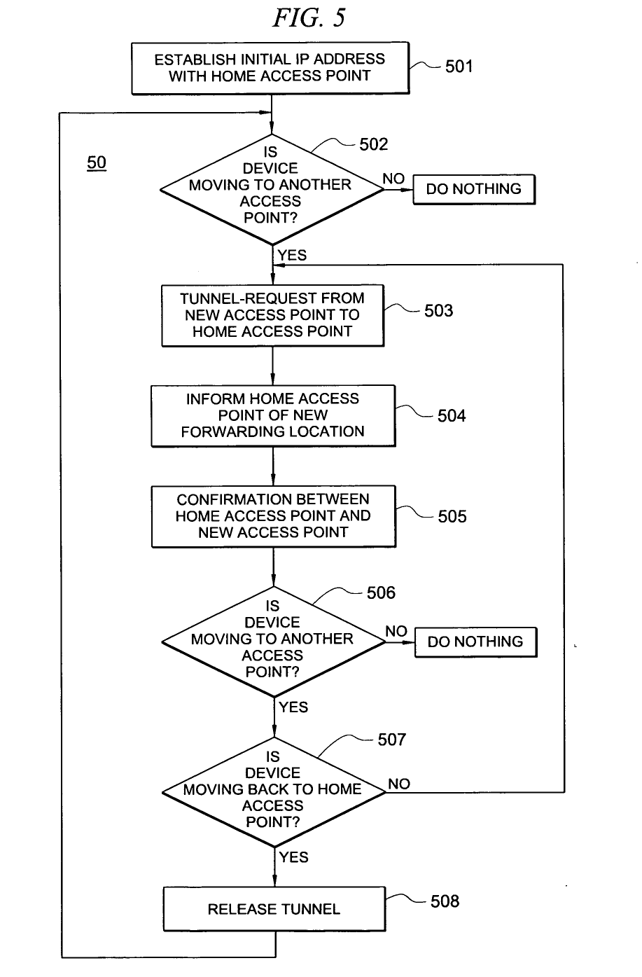

FIG. 5 illustrates one embodiment 50 of a method for achieving the objectives of the invention. Process 501 establishes the initial IP address with the home access point, which in the illustration is access point 12 of FIGS. 1 through 4C. Process 502 determines whether the device is moving to another access point, or whether the home access point will continue serving the device. If the device is not moving away from the home access point, nothing is done. If it is, then a tunnel request from the new access point to the home access point is established via process 503.

In process 504, the new access point informs the home access point that a new access point will serve the device. The home access point sets up a tunnel to forward data to the new access point. In process 505, an optional confirmation is made between the new and home access points to confirm that the tunnel has been set up successfully.

In process 506, a determination is made, similarly as discussed above, as to whether the current access point will remain serving the device, or whether the device is moving to another access point. If the device remains with the current access point, no changes are made. If the device is moving, process 507 determines whether the device is returning to the home access point. If the device is returning to the home access point, the tunnel is released in process 508. The home access point becomes the serving access point, which returns method 50 to process 502.

If, however, the device is moving to a new access point that is not the home access point, the data will need to be forwarded to the new access point. Method 50 then returns to process 503. On this and subsequent returns to process 503, process 503 optionally removes any previous access points that are not the home access point.

Note that during any travel, device 11 will maintain the same IP address, regardless of its access point, and there need not be multiple intermediate access points for the system to operate. Also, note that while the handoffs and transfers from one access point to another have been described in the context of device 11 moving, transfer of access point control may be made based on access point availability. That is, device 11 may be transferred to a new access point without device 11 actually moving, but rather because the serving access point becomes overburdened or experiences a failure.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of wireless system operation, said method comprising:
establishing an air interface between a first network access point and a mobile device having an IP address, said IP address operative for facilitating communications between said mobile device and said network through said first access point;
establishing an air interface between said mobile device and a second network access point; and
routing at least some of said communications between said network and said mobile device through said second access point using said IP address established at said first access point.

2. The method of claim 1 further comprising:
establishing an air interface between said mobile device and a third network access point; and
releasing said second access point such that communications between said mobile device and said network flows through said third access point without changing said IP address of said mobile device.

3. The method of claim 1 wherein said releasing comprises:
sending a message to said second access point, said message having contained therein information for allowing said second access point to release control of said mobile device without requiring said mobile device to change IP addresses.

4. The method of claim 1 wherein said releasing comprises:
sending a message to said first access point, said message having contained therein information for allowing said first access point to direct traffic to said mobile device without requiring said mobile device to change IP addresses.

5. The method of claim 2 wherein said routing comprises:
changing the routing of communications within said network so that communications from said network to said IP address of said mobile device are directed to said second network access point.

6. The method of claim 1 further comprising:
assigning said IP address of said mobile device using DHCP.

7. The method of claim 1 wherein said IP address of said mobile device is static.

8. The method of claim 1 further comprising:
establishing an air interface between said mobile device and a third network access point; and
routing at least some of said communications between said network and said mobile device through said third access point using said IP address of said mobile device.

9. The method of claim 7 wherein when said air interface is established between said mobile station and said third access point said mobile device is beyond the range of an air interface between said mobile device and said first air access point.

10. The method of claim 9 further comprising:
releasing said second access point such that all communications between said mobile device and said network flows through said third access point without changing said previously assigned IP address of said mobile device.

11. The method of claim 10 wherein said releasing comprises:
sending a message to said first access point, said message having contained therein information for allowing said second access point to release control of said mobile device without requiring said mobile device to change IP addresses.

12. An air interface access point comprising:
means for accepting a request from a mobile device, said mobile device having previously been assigned a communication network address and communicating with said communication network via another access point, said another access point being separate from said access point; and
means for facilitating communications from said communication network to said mobile device using said previously assigned communication network address.

13. The access point set forth in claim 12 wherein said request is accepted over an air interface established between said access point and said mobile device.

14. The access point set forth in claim 12 wherein said facilitating comprises:
accepting communications from said network having said previously assigned network address associated therewith.

15. The access point set forth in claim 12 wherein said facilitating comprises:
means for sending a message to said another access point, said message having contained therein information for allowing said another access point to release control of said mobile device without requiring said mobile device to change communication network addresses.

16. A system for handling subscriber devices over a network common to said subscriber devices, said system comprising:
a subscriber device with one or more addresses; and
two or more access points comprising handoff control allowing said subscriber device which is communicating with a first one of said access points to communicate with a second one of said access points via an air interface between said subscriber device and said second access point; such that communications to said subscriber device from said network are delivered from said network to said second access point via said first access point and to said subscriber device over an air interface between said subscriber device and said second access point.

17. The system of claim 16 wherein said subscriber devices are mobile.

18. The system of claim 16 further comprising:
means for causing said second access point to become disassociated from said subscriber device while still allowing said subscriber device to receive communications from said first access point using said address of said subscriber device.

19. The system of claim 18 further comprising:
a third one of said access points for communicating with said subscriber device over an air interface; and
means for transferring control of communications from said network to said subscriber device to said third access point.

20. The system of claim 18 wherein said address of said subscriber device does not change.

21. The system of claim 16 wherein said first access point assigns said subscriber device address.

22. The system of claim 21 wherein said address is an IP address assigned using DHCP.

23. The system of claim 16 further comprising:
means for routing communications from said subscriber device to said network via said first access point.

24. The system of claim 16 further comprising:
means for routing communications from said subscriber device to said network without going through said first access point.
